(19) United States
(12) Patent Application Publication
(10) Pub. No.: US 2010/0285884 A1
(43) Pub. Date: Nov. 11, 2010

(54) High performance network art rendering systems

(75) Inventors: Franklin M. Gauer, III, Centennial, CO (US); Scott Brown, Louisville, CO (US)

Correspondence Address: INTEGRITY IP, P.O. BOX 757, LA JOLLA, CA, 92038, US

(73) Assignee: Gazillion Inc

(21) Appl. No.: 12/387,858

(22) Filed: May 8, 2009

(51) Int. Cl. A63F 13/00; A63F 9/24

(52) U.S. Cl. 463/42

(57) ABSTRACT

Computer games deployed over communications networks such as the Internet are arranged with graphics rendering services to effect a real-time, automated fast rendering facility responsive to requests generated in view of game execution state. High-performance graphics authoring tools are used to produce graphics elements in agreement with a particular game design and scenario specification ‘on-the-fly’. These graphics are uploaded and stored in a database having a cooperating prescribed schema. A media player executing game logic is coupled to a render manager whereby render requests are passed thereto. The render manager forms scene files to be processed at a rendering application and finally to an assembler which converts all rendered graphics to a form usable at the media player. In this way, very high-quality real-time automated graphics generation is provided for bandwidth and memory limited platforms such as user workstations coupled to the Internet.

### BACKGROUND OF THE INVENTIONS

1. Field

The following invention disclosure is generally concerned with network gaming systems and more specifically concerned with network gaming systems having automated fast (real-time or near real-time) art rendering services and facility responsive to game execution.

2. Prior Art

Without doubt, modern Internet gaming is exciting as Internet gaming systems become more advanced each day. Network games deployed over the Internet attract greater numbers of participants with each advance in technology which tend to promote ever increasing realism, fast pace and excitement.

It is an important concern for game designers to provide realistic games with highly dynamic images and action which respond readily and quickly to the ever-changing circumstances and states of the game play as controlled by a prescribed game definition.

One very important component for some modern Internet gaming systems is an application produced and maintained by Adobe Systems called “Flash” media player. A Flash type media player is a module resident at a user workstation, e.g. a ‘desktop workstation’, which operates to play audio and visual media in conjunction with execution of program code sometimes and herein called “ActionScript”. Game designers may use Adobe technologies such as media development tool “Adobe Flash CS4 Professional” to author game systems. The output of this authoring tool can be a computer file in a special format such as ‘.swf file’. This .swf file, when executed by a Flash player on a game consumer's machine permits the user to interact with game elements for example by game peripheries like a joystick, or ‘mouse clicks’ and keyboard entries. Game feedback to the user may be visual, for example by a graphical images presented at a monitor, or audio, for example sound effects played on a speaker system. While many game execution platforms exist, Flash is a most dominant and most important leading technology.

It is possible to provide a complete .swf file to a user/game player prior to initiation of gameplay whereby all possible scenarios are accounted for in execution code and included art elements. This is a most simple form of a Flash game. From start to finish, the Flash player executes the .swf file which includes the complete game logic and all images and sounds which are part of the game. Without receiving any updates or other messages from outside sources, the entire game is comprised exclusively of the Flash player and .swf file containing the game definition. A fully self-contained game as described is a most popular version of Flash game and is currently in very widespread use. However it necessarily has certain important limitations which prevent useful game dynamics. Where the game code is not updated or changed during the course of play, the game is not responsive to events and conditions which might occur outside the immediate system where the game is executed. That is, the game may be mostly limited to local activity i.e. the activity which takes place at the local machine.

In some special high-performance game versions, code executed by a Flash player may include certain calls to outside (remote) Web services whereby gameplay is responsive to objects passed into the player via the Internet. That is, Flash type games may be made responsive to remote servers designed to receive calls from the game being executed at a user workstation, whereby the server responds by conveying into the game logic programming code or ‘objects’ or other parameters including states thereof. Further game execution may thereafter depend upon information passed from the server. It can be easy and fast to pass via the Internet parameter data and simple objects from a cooperating server to a Flash game systems. Indeed, this type of activity greatly enhances gameplay in many aspects.

One most important way in which this enhances gameplay relates to multiuser games where several users are engaged in play simultaneously. When either player takes some action, that action might affect presentation of the game state as viewed by the other player. A server liaison or ‘go-between’ administers and manages conveyance of data between two players and each player has a local execution of the game (via Flash player/game code) which responds to data shared between the two executing game instances. For large percentage of modern multiplayer games deployed about the Internet, a version similar to the one described permits interactions between players separated by great distances. These games are exciting and highly dynamic and as such, attract an ever-growing gaming community. These multiplayer games of very high performance nevertheless remain encumbered with other limitations. One major limitation relates to the bandwidth. The Internet as a communications medium remains restricted by bandwidth limitations. As game systems tend to be image/video intensive, bandwidth limitations can limit the quantity of content which can be passed between players and a server. Particularly, real-time multiplayer games have no difficulty passing simple objects and parameters between discreet computing systems, however it can be prohibitively difficult to pass complex graphical or video images between systems due to bandwidth limits.

For highest performance, highest realism, in multiplayer games, it is essential to devise cooperating server systems coupled to a communications network to be bandwidth efficient. Accordingly, there is a great need for systems and techniques which improve multiplayer game realism by efficient use of limited bandwidth for Internet coupled games based upon a media player such as the Flash player platform.

While systems and inventions of the art are designed to achieve particular goals and objectives, some of those being no less than remarkable, these inventions have limitations which prevent their use in new ways now possible. Inventions of the art are not used and cannot be used to realize the advantages and objectives of the invention taught herefollowing.

### SUMMARY OF THE INVENTION

Comes now, Franklin M. Gauer III and Scott Brown with an invention of network gaming systems for automated dynamic art rendering including devices and methods. It is a primary function of these network game systems to provide highly dynamic, fast response, art rendering services coupled to a game execution. It is a contrast to known methods and devices that systems first presented here do not include an entirely predefined set of art assets, but rather are characterized as having rendering facility responsive to game execution which produces needed art assets ‘on the fly’.

Systems first presented here are devised with highly dynamic automated art rendering facility and technique to realize most realistic and responsive game play experience. A server computer system or plurality of servers arranged in a ‘server farm’ is/are in communication with a media player apparatus to provide very high speed automated art preparation and delivery to media players simultaneous with game execution. In a most preferred version, a Flash player type media player including a program component (ActionScript) makes requests (“render requests”) for art which is anticipated for use in future execution of game logic. This request for art is conveyed to a remote server configured and arranged with special purpose to provide fully automated rendering services—human input is not required—the server responds to parameters and specifications of the art render request and assembles a set of art elements appropriate for future gameplay and further provides these in a format readily received and consumed by a media player, e.g. Flash player. A .swf file including a ‘sprite sheet’ containing various implementations of these art elements is one most preferred implimentation. Upon receipt of the sprite sheet from the fast rendering server(s), the game logic may call and use these newly created art assets with continued execution of the game.

These systems are quite distinct from those of the arts. In game systems presently deployed, art exists and is fully defined prior to start of game play. Art assets are stored in a memory and many are stored, but none are created during execution of the game. This is a very important point of distinction in the present invention; the instantaneous states of gameplay determines the appearance of art to be rendered and art rendering is performed in near real-time as the game is played. That is, art is produced in response to the circumstances which arise during execution of the game. In this way, the graphical appearance of the game is responsive to the game execution. In previously known systems, the finite graphics are prepared and fully defined prior to initiation of the gameplay.

To bring about these systems, a render server is prepared with vast database of ‘root’ or ‘primary’ graphical elements which may be recalled as needed. Various of these root graphical elements may be assembled together in many combinations to realize a great plurality of compound graphical units. After a compound graphical unit (e.g. game character or avatar) is formed, it may be automatically further operated upon by a high-performance rendering application such as Mental Ray by way of the rendering application's API. The database is coupled to the rendering application by way of a rendering management module such that requirement for human input is not necessary—the system is a fully automated machine. The output of the rendering engine may be further processed for example by the Adobe Flash authoring tool to finally arrive at a .swf file output which may be readily used by the Flash media player during game execution. Thus the server which provides these highly dynamic, high-speed rendering services provides a game newly created art while the game is being executed.

### OBJECTIVES OF THESE INVENTION

It is a primary object of the invention to provide new network gaming systems having dynamic art rendering facilities.

It is an object of these inventions to provide near real-time art rendering services to media players executing game logic.

It is a further object to provide Internet games highly dynamic and powerful automated art rendering services.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a system block diagram of primary elements and relationships between them;

FIG. 2 is a prior art example of art assets represented as a ‘sprite sheet’;

FIG. 3 illustrates an important alternative version in a block diagram;

FIG. 4 expands further the example of FIG. 3 with some particular preferred implimentations; and

FIG. 5 further illustrates in block diagram details of certain versions of these systems with particular attention to a ‘render request’ call.

### Glossary of Special Terms

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Server Farm

A collection of computing systems arranged as servers which operate in a cooperative manner to address requests for computing services.

### Rendering Application

A graphics based computer module or application which provides art rendering functionality.

### Art Asset

A bitmap, image, sprite sheet, image series, video, or other graphical element embodied as stored code.

### PREFERRED EMBODIMENTS OF THE INVENTION

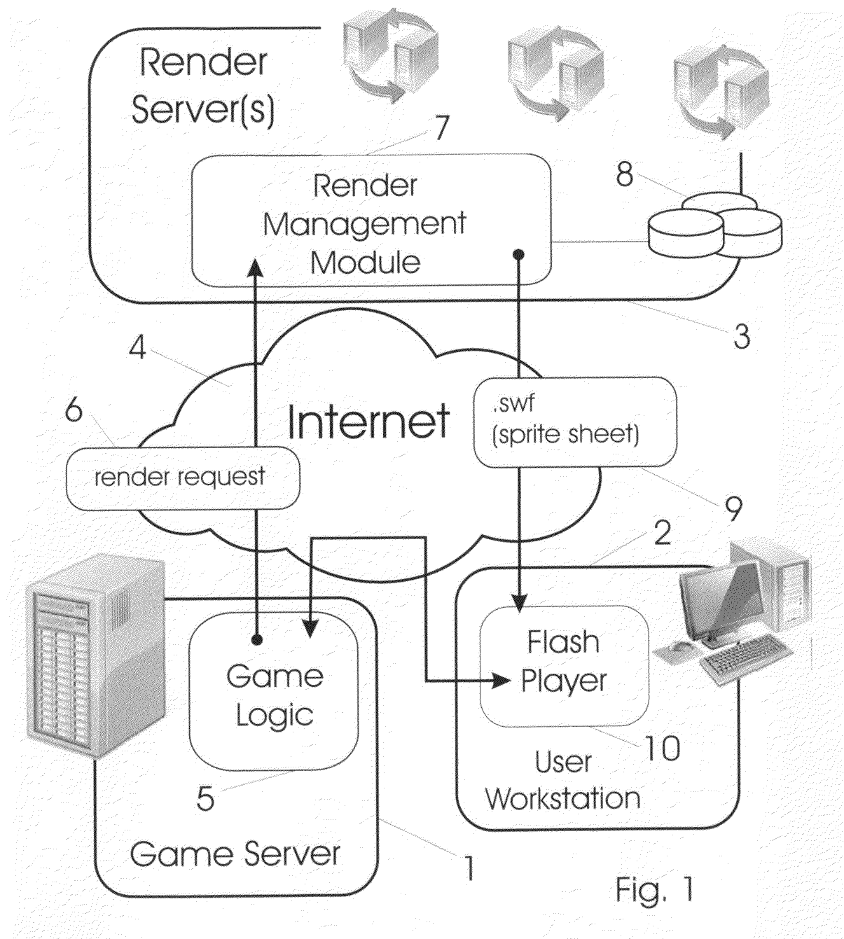

One first illustrative example version of these network game apparatus is presented as FIG. 1. In this version, a game server 1 is arranged to host gaming services which may be consumed via computing systems fashioned as user workstations 2. In addition, a render server or plurality of render servers 3 arranged as a ‘server farm’ may additionally cooperate with the game server and user workstation to form a complete system. Each of these elements: ‘game server’, ‘user workstation’ and ‘render server’ may be communicatively coupled together via a communications network for example the Internet 4. Game logic 5 executed at the game server may arrive at an execution state where a need for certain art assets are anticipated for future stages of game play. Accordingly, a ‘render request’ 6 call is formed and transmitted to a render management module 7 for processing. In response to receipt of a render request, a render management module recalls root or primary graphical elements or images from a game specific set of previously prepared graphics logically sorted and stored in a database 8 by way of a prescribed schema known to the game logic. Render requests are formed in view of the known database structure and content. In this regard, the database schema and game logic are said to be cooperatively coupled.

Graphical elements or ‘art assets’ are recalled from the database. A plurality of these elements may be assembled together to form compound graphical elements and those are further assembled as set of characters in a sprite sheet. Thereafter, those compound graphical elements are subject to advanced rendering processes in further view of specifications of the render request. For example, lighting, camera angle, et cetera. The sprite sheet is then wrapped in a format compatible with the specific media player of the user workstation. Where a Flash type media player is used, a sprite sheet may be prepared as a .swf file and passed via the Internet from the render server to the user workstation where it may be put into local memory for fast and ready access.

In this way, fantastic richness of character sets is available without having to provide an enormous memory at the user workstation. Indeed, infinitely large selections of character sets become available in near real-time to game logic as it is executed. When the game execution advances to a different state, then a new request for additional pertinent art may be made so the Flash player has access to still more exciting art.

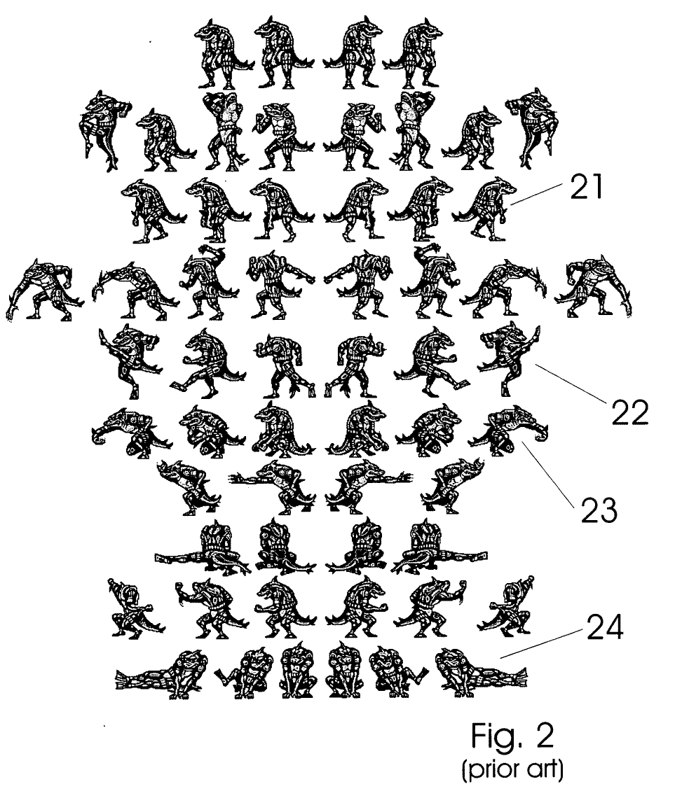

To achieve very high realism in computer games, it is necessary to develop art assets having a plurality of sprites to represent various positions/stances/actions of a single character. By playing through a prescribed sequence of sprites, one may simulate desired motion or actions. The greater the number of sprites representing a character in an action sequence, the more realistic a video series can seem. Accordingly, game designers prefer to develop sprites having several frames to represent any single action. To illustrate, consider the prior art sprite sheet example of FIG. 2. A sequence 21 of three graphic elements or ‘sprites’ cooperate together to simulate a frog avatar walking to the right. Three additional sprites are provided as mirror images to support the same character walking to the left. A ‘flying kick’ series 22 of graphical images similarly has left and right versions. A ‘crouched attack’ may be represented as yet another series of ‘frames’ 23. Finally a ‘sidekick action’ 24 is represented by still further another series of frame images.

Together, the graphic elements of FIG. 2 may account for all action in which the frog character is permitted during a game execution. These sprites are developed and completed and stored into a game file which is played at a media player after all art has been finalized and fully rendered. The art set is fully defined and does not change during execution of the game. That is, the art set or art assets are not responsive to changes in the game state. This is a most typical manner in which art assets are provided in support of computer video games and especially so in the Flash methodology.

If one were to desire a more realistic game, then rich character sets having hundreds or even many hundreds of image series would need to be developed during a game's design and stored as character sprite sheets similar to those described above. However this technique is prohibitively taxing with respect to artist labor, memory consumption, bandwidth, among others.

Network game systems first presented and taught here do not attempt to store discrete images in the manner of the arts. No attempt is made to account for every possible static stance and position a character may be represented in during game execution by way of a collection of individual sprites. Rather, compound characters and other graphical elements and objects are carefully sorted and stored as primary graphics in a well organized database. For example, a specific character's torso; head; arms; and legs may be defined for various actions, in example: running; walking; standing; attack; strong attack; and retreat. Further, a character's armor and/or weapons and other accessories may still further be stored as separate primary graphics with associations to various actions, scenes or scenarios.

When the course of game execution calls for a scene in which a character is running on an angle of 30° for example, then the appropriate primary elements may be recalled from the database and assembled as a compound character image. Such compound character images may be further operated upon with rendering processes to account for variations in lighting or perspective for example. Image processing routines applied to a primary image may yield a modified image having variations which give a certain prescribed appearance or attribute to the resulting modified image.

It should be immediately clear to experts that any attempts to save as part of the game code a great plurality of images accounting for every possible lighting circumstance and camera angle would be prohibitively burdensome with respect to bandwidth and memory; and further clear that preparing these only when needed offers great relief from the resource limitations with the result being a highly realistic fast game with very sophisticated images.

Because games having a very high degree of realism may require so many variations of character sprites, it is preferable to generate them ‘on-the-fly’ rather than store them as complete set in a local memory. As local computing processing capacity is quite insufficient for automatically generating character sets in real-time, near real-time, or during game execution (run time), it is preferable that this art asset rendering be taken up at remote stations where greater processing power and sophisticated rendering facility are available. Accordingly, remote render servers of very high-performance are devised with game specific databases previously loaded with game graphic primaries, and further equipped with high-performance rendering facility provide the foundation upon which one may effect a real-time art asset rendering system responsive to a game execution at runtime.

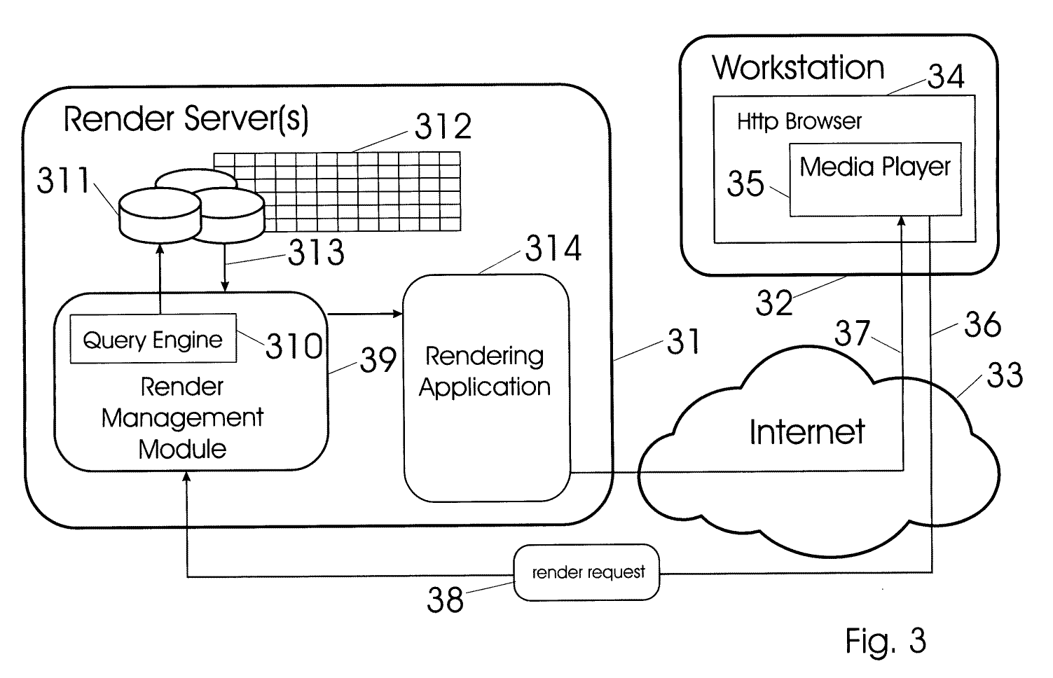

A system block diagram representing another alternative preferred example version is presented as FIG. 3 where a render server 31 is coupled to a user workstation 32 via the Internet 33. In one most useful example, a common Internet browser 34 hosts a media player component 35. A media player is operable for playing or executing various media to affect a user presentation (i.e. audio/video/graphics etc.) at computer peripheries including display monitor and speakers among others. The media player may additionally operate to make outgoing service requests 36 to remote servers and also receive incoming service responses 37.

In one most important example version, service requests may include those characterized as “render requests” 38. A render request is distinguished from other requests by its characteristics which relate to rendering of stored art assets. In one example, game code being executed at a media player, the game code having a priori knowledge of particular attributes and properties of stored art assets, invokes a render request which specifies the nature of graphical elements to be rendered in view of the particular instantaneous state of gameplay.

A render management module 39 of a render server receives render requests and parses them. From information of the render request, where that information relates to art assets needed at the game in accordance with the particular current state of gameplay, a query engine 310 forms database queries which can be executed against image data carefully stored in database 311 via a special purpose database schema 312. In response to queries executed against the database, results return a collection of graphical elements 313 to the render management module. Thereafter, and in further view of parameter data from the parsed render request, the render manager prepares a special file with graphical elements and render instructions and passes this file to a rendering application 314. The rendering application operates upon the graphical elements to manipulate them and modify them whereby their final state reflects further characteristics specified in the render request. In another processing step, an assembler prepares rendered graphical information in a format more readily consumed by the media player including any tags and/or overhead demanded by same.

The above description is directed to a scenario where during gameplay requests and returns are exchanged between a media player and render server(s). In real-time with respect to a game timeline, circumstances of gameplay result in render requests being transmitted from the media player to the render server and render results being thereafter returned to the media player for use in further execution of the game.

One exceptionally important element of these systems is the render management module. The render management module is responsive to parameters of received render requests and automatically prepares appropriate rendering instructions and attaches those to appropriate art assets prior to sending this information to a rendering application. Heretofore, certain systems have taken similar steps via manual operations performed by human operators (of course, precluding real-time operation, or art rendering operations performed during and in response to execution of game code), but a render management module of these systems is fully automated and requires no human input whatever; rather, the parameters of the render request completely specify the rendering which is needed and the render manager prepares rendering instructions in accordance therewith to direct the rendering application.

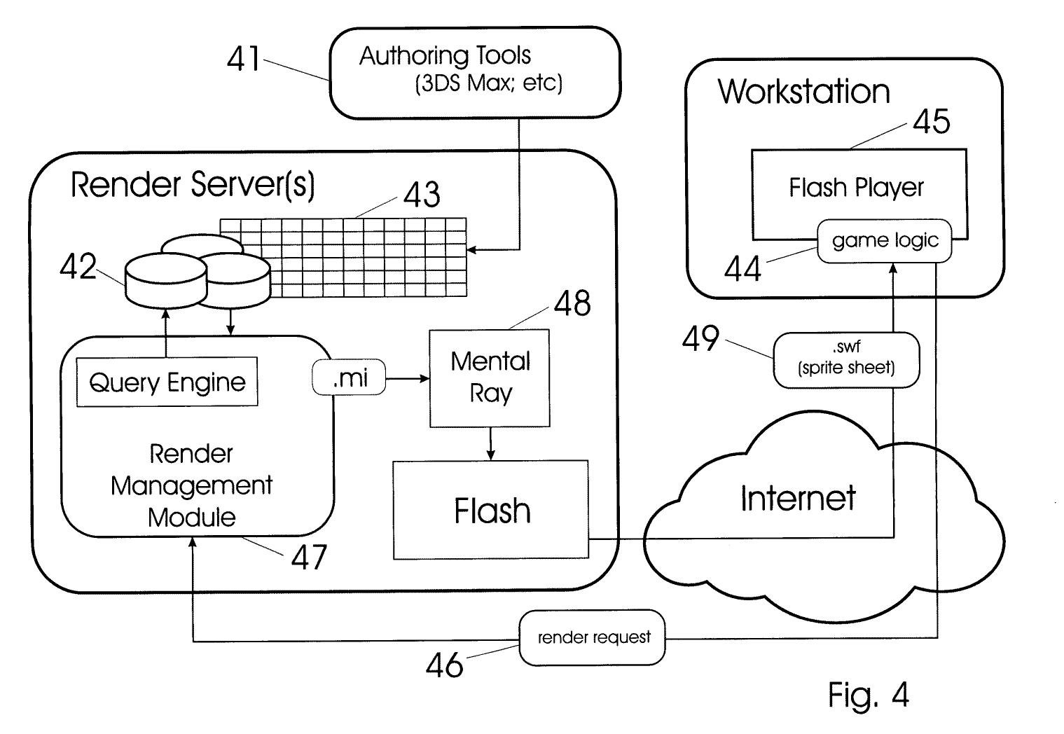

This may become immediately more clear to competent artisans in view of the following best mode example with references to FIG. 4. High performance 3D graphical authoring tools 41, for example one preferred and widely used known as ‘3D Studio Max’ produced and distributed by Autodesk USA, are used to develop art assets or graphical elements. With respect to game technologies, ‘art assets’ mean for example game characters, elements, objects, and game features or other graphical component of a game user interface. For example, a warrior character may be used to represent a player as his game identity. An enemy or opponent character, for example a dragon character under control of the game logic may be resented in opposition to goals of the player. These characters ‘Warrior’ and ‘Dragon” are preferably embodied as graphical representations. Authoring tools described above are ideal for creating most realistic high-quality graphical representations used in computer games.

To give a realistic appearance of motion and action, the characters and/or other art assets may be developed in a plurality of states and sequences to simulate particular actions or activity. For example, a series of ‘frames’ may be developed to effect a walking sequence. When the game play timeline calls for a character to walk, a series of graphics developed in cooperation with others is presented to give the appearance of a character walking. When a game developer designs her game, actions and characters are well planned and accounted for, and authoring tools are used to create characters in various poses and actions whereby these may be called from memory and presented on a game ‘stage’ or display field as the game is executed.

In games of the prior art, game assets are fully developed and stored as part of the game code. Although memory intensive, it has heretofore been impossible to develop assemble and render art assets on-the-fly or in response to game execution states. As such, the art assets which may be used in typical computer games are very limited. A first severe limit is memory. Graphical images can consume memory resources and especially when high-resolution graphics are used. Further, when games include high-resolution images bandwidth limitations can further restrict game performance.

Because of these limitations among others, it is preferable that characters be developed in set of character components and still further in sets of character components with associations to various gameplay actions. These character components are carefully stored in a relational database 42. The components can then be recalled and assembled together in a great plurality of combinations to bring about extremely rich and highly diverse unique variations. Since the set of possible images does not need to be stored in memory, but rather is prepared as a game is played, the set of images which can be used in the game play is unlimited. In striking contrast, the image sets of today's games is strictly limited by memory and speed constraints.

The database necessarily has a prescribed and specifically prepared schema 43; this schema having been prepared in view of a particular game design attributes. That is the database schema is necessarily matched with game methodology rules and objectives as defined by the game logic 44.

Because there is a prescribed relationship between game logic and the database schema, the game logic being executed at a Flash player 45 may call for needed rendering services by formulating a render request 46 in view of certain circumstance and state of gameplay, and transmit that render request to the render server, and more particularly to the render management module 47.

In example, one particular game circumstance may call for a warrior character in a ‘strong attack’ mode with a sword advancing on a 30° angle and a dragon character in running retreat mode on a 45° angle. As a result of such circumstance arising in a game of these systems, a render request including parameters which define the specifics mentioned is conveyed to the render management module. Graphical components associated with these conditions are recalled from the database in response to execution of the appropriate query. Further, the render management module adds to these recalled graphical components specification of game conditions such as lighting, i.e. a moonlit night, and perhaps a camera angle, or texture definitions, among others.

In special versions which deploy a preferred rendering application such as the industry leader “Mental Ray” the graphical components and other specification are assembled with rendering instructions as a ‘scene’ or ‘.mi’ file and processed at a Mental Ray instance. The output of the Mental Ray rendering application is then passed to an Adobe/authoring application where calls to its API are made to finally arrive at a .swf file output including a ‘sprite sheet’ containing a set of characters for filling the rendering objectives of the render request. This sprite sheet is passed into the Flash player and game logic whereby its content may be invoked and played as part of the game.

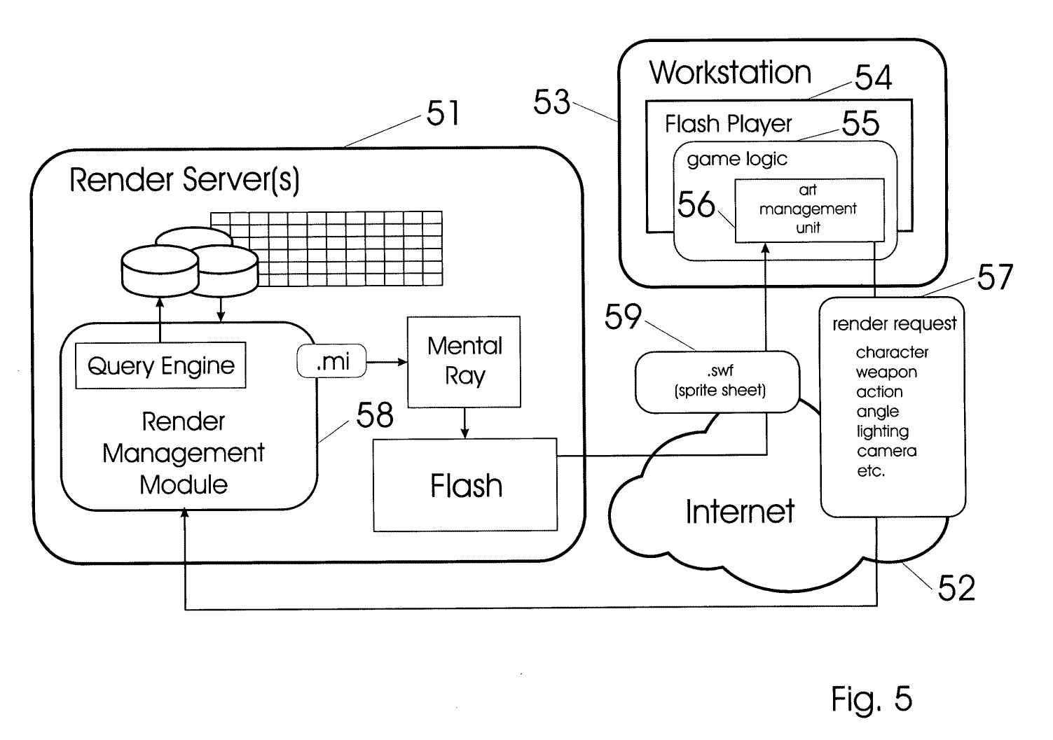

FIG. 5 illustrates another important component of these systems which clearly distinguishes them from similar systems of the arts. A remote render server 51 is coupled by way of the Internet 52 to a user workstation 53. The workstation is preferably equipped with an Internet browser system but in any case includes a Flash player type media player 54. A particular component of the Flash player is a game logic module 55 which includes an art management unit 56. The art management unit is particularly arranged to form render requests in view of an execution state of the game logic. In response to some prescribed conditions of which are infinitely many and highly variable, the art management unit prepares a request for art assets of a certain nature.

In one illustrative example, an art management unit is stimulated into action upon the firing of a program event. In response thereto, a render request 57 which specifies need for art assets of a nature defined by parameters of the render request. To illustrate, a particular game character may be needed such as a warrior, further the weapon carried by the warrior may be specified as a sword; it may be further specified in the parameters of the render request that the warrior who carries a sword is to be rendered in an attack stance and configuration (action) and further that the attack action will take place on an angle 30° with respect to the display field. Further, the render request parameters may additionally account for environmental and scene attributes such as a specification for lighting and camera angles. Together, these parameters which describe and specify art needed for further execution of the game make up the render request. Of course, the careful observer will fully appreciate that while this example illustrates compositions of an important type of render request, it is clear that many alternative types of render requests where additional or fewer parameters will fully define art assets needed by various game logic executions.

In response to an art management unit which transmits a render request as described to a render management module 58 of these inventions, a .swf file including a sprite sheet of well prepared art elements is returned into the game logic for later as execution advances further.

In accordance with each of preferred embodiments of the invention, network game systems having highly dynamic art rendering facility responsive to game execution are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

What is claimed is:

1) Network game apparatus comprising a user workstation coupled by the Internet to at least one render server.

2) Network game apparatus of claim 1, said render server is characterized as a computing system arranged to provide art rendering services in response to remotely executed computer game modules.

3) Network game apparatus of claim 2, said render server is comprised of a database of predefined graphical elements specific to a game executed on said user workstation.

4) Network game apparatus of claim 3, said render server further comprises a render management module arranged to receive render requests from a remotely executed game execution and provide rendering responses in return thereto.

5) Network game apparatus of claim 3, said render management module comprises a query engine operable for running database queries against game specific graphical data stored in said database.

6) Network game apparatus of claim 3, said render management module comprises facility for preparing a scene ‘.mi’ file and conveying to a ‘Mental Ray’ instance for execution there without human input.

7) Network game apparatus of claim 2,
said render server is comprised of:
a database;
a rendering application; and
a render management module,
said database is arranged to receive queries from said render management module and return art elements to said rendering application,
said rendering application is arranged to receive art elements from said database and rendering commands from said rendering management module and further to operate upon those art elements and produce as output modified art elements.

8) Network game apparatus of claim 3, where said rendering application output is further manipulated upon to form a Flash compatible ‘.swf’ file.

9) Network game apparatus of claim 3, said rendering application is characterized as a ‘Mental Ray’ type rendering application.

10) Network game apparatus of claim 1, said at least one render server is characterized as a server farm.

11) Network game apparatus of claim 1,
said workstation comprising a general purpose computing system, a network port, and a media player module whereby said media player module is communicatively coupled by way of the network port to the Internet,
said render server comprising: a render management module, a database, rendering application and network port whereby said rendering application is communicatively coupled by way of the network port to the Internet.

12) Network game apparatus of claim 11,
said media player module is further comprised of game logic; and
said database is further comprised of a database schema, said database schema and said game logic are cooperatively coupled.

13) Network game apparatus of claim 2,
said media player is characterized as a “Flash” type media player, and
said rendering application is a further characterized as a “Mental Ray” type rendering engine.

14) Network game apparatus of claim 2, said media player module is comprised of an art management unit arranged to form and transmit render request calls to the render management module, the art management unit is further arranged to receive sprite sheets specific to the instantaneous state of gameplay.
